(19) United States
(12) Patent Application Publication
(10) Pub. No.: US 2026/0222944 A1
(43) Pub. Date: Jul. 30, 2026

(54) INFORMATION TRANSMISSION METHOD AND APPARATUS, AND STORAGE MEDIUM

(71) Applicant: Beijing Xiaomi Mobile Software Co., Yard 33, Beijing (CN)

(72) Inventor: Xiaolong LI, Beijing (CN)

(73) Assignee: Beijing Xiaomi Mobile Software Co., Yard 33, Beijing (CN)

(21) Appl. No.: 19/143,607

(22) PCT Filed: Dec. 28, 2022
(86) PCT No.: PCT/CN2022/142926

§ 371 Date: Jun. 26, 2025

(51) Int. Cl. H04W 36/08; H04W 36/00

(52) U.S. Cl. CPC H04W 36/08; H04W 36/0061

(57) ABSTRACT

A method and device for information transmission in a wireless communication system. In one aspect, a terminal reports indication information to a network-side device to indicate whether the terminal successfully receives system information that includes a cell handover parameter broadcast by the network. The indication information may be triggered based on receipt of a radio resource control (RRC) message configuring a terminal-specific handover parameter, or based on detection of an update to the system information. If the terminal fails to receive the system information, the network-side device may transmit the handover parameter via a dedicated RRC message. Corresponding methods performed by the network-side device and devices configured to execute the disclosed methods are also provided. The disclosed techniques improve the robustness and reliability of handover procedures in wireless networks.

### CROSS-REFERENCE TO RELATED APPLICATIONS

This application is a national stage of International Application No. PCT/CN2022/142926, filed on Dec. 28, 2022, which is hereby incorporated by reference in its entirety.

### TECHNICAL FIELD

The present disclosure relates to the field of communication, and in particular, to an information transmission method and apparatus, and a storage medium.

### BACKGROUND

Currently, in a non-terrestrial network (NTN), a terminal may receive system information including a cell handover parameter broadcast by a network-side device, and receive a terminal-specific cell handover parameter sent by the network-side device to the terminal through an RRC (Radio Resource Control) message.

However, if the terminal does not correctly receive the system information, the cell handover fails.

### SUMMARY

To solve problems in the related arts, embodiments of the present disclosure provide an information transmission method and apparatus, and a storage medium.

According to a first aspect of the embodiments of the present disclosure, an information transmission method is provided, performed by a terminal, including:
the method is performed by a terminal and includes:
reporting indication information to a network-side device, where the indication information indicates whether the terminal successfully receives system information including a cell handover parameter broadcast by the network-side device.

Optionally, the cell handover parameter includes:
a common parameter for handover to a target cell.

Optionally, the method further includes:
in response to determining that a system information block including the cell handover parameter is successfully received, determining that the system information is successfully received; and/or
in response to determining that a valid system information block including the cell handover parameter is stored, determining that the system information is successfully received.

Optionally, where reporting the indication information to the network-side device includes:
in response to receiving a first radio resource control (RRC) message sent by the network-side device, reporting the indication information to the network-side device through a second RRC message, where the first RRC message is used to configure, for the terminal, a terminal-specific parameter for handover to a target cell.

Optionally, where reporting the indication information to the network-side device includes:
in response to determining that the system information including the cell handover parameter is updated, reporting the indication information to the network-side device.

Optionally, where reporting the indication information to the network-side device includes:
in response to receiving a first RRC message sent by the network-side device, reporting the indication information to the network-side device through a second RRC message, where the first RRC message is used to configure, for the terminal, a terminal-specific parameter for handover to a target cell; and
in response to determining that the system information including the cell handover parameter is updated, reporting the indication information to the network-side device.

Optionally, the first RRC message is an RRC reconfiguration message; and/or the second RRC message is an RRC reconfiguration complete message.

Optionally, the method further includes:
receiving a request message sent by the network-side device, where the request message is used to request the terminal to report the indication information;
where reporting the indication information to the network-side device includes:
reporting the indication information to the network-side device based on the request message.

Optionally, the method further includes:
in response to determining that the indication information indicates that the terminal fails to receive the system information, receiving a third RRC message sent by the network-side device, where the third RRC message at least includes the cell handover parameter.

Optionally, the third RRC message includes at least one of:
a system information block including a common parameter for handover to a target cell;
the common parameter; or
the common parameter and a terminal-specific parameter for handover to the target cell.

According to a second aspect of the embodiments of the present disclosure, an information transmission method is provided, performed by a network-side device, including:
receiving indication information reported by a terminal, where the indication information indicates whether the terminal successfully receives system information including a cell handover parameter broadcast by the network-side device.

Optionally, the cell handover parameter includes:
a common parameter for handover to a target cell.

Optionally,
receiving the indication information reported by the terminal includes:
after sending a first radio resource control (RRC) message to the terminal, receiving the indication information reported by the terminal through a second RRC message, where the first RRC message is used to configure, for the terminal, a terminal-specific parameter for handover to a target cell.

Optionally, receiving the indication information reported by the terminal includes:
receiving the indication information reported when the terminal determines that the system information is updated.

Optionally, receiving the indication information reported by the terminal includes:
after sending a first RRC message to the terminal, receiving the indication information reported by the terminal through a second RRC message, where the first RRC message is used to configure, for the terminal, a terminal-specific parameter for handover to a target cell; and
receiving the indication information reported when the terminal determines that the system information is updated.

Optionally, the first RRC message is an RRC reconfiguration message; and/or
the second RRC message is an RRC reconfiguration complete message.

Optionally, the method further includes:
sending a request message to the terminal, where the request message is used to request the terminal to report the indication information;
receiving the indication information reported by the terminal includes:
receiving the indication information reported by the terminal based on the request message.

Optionally, the method further includes:
in response to determining that the indication information indicates that the terminal fails to receive the system information, sending a third RRC message to the terminal, where the third RRC message at least includes the cell handover parameter.

Optionally, the third RRC message includes at least one of:
a system information block including a common parameter for handover to a target cell;
the common parameter; or
the common parameter and a terminal-specific parameter for handover to the target cell.

According to a third aspect of the embodiments of the present disclosure, an information transmission apparatus is provided, applied to a terminal, including:
a reporting module, configured to report indication information to a network-side device, where the indication information indicates whether the terminal successfully receives system information including a cell handover parameter broadcast by the network-side device.

According to a fourth aspect of the embodiments of the present disclosure, an information transmission apparatus is provided, applied to a network-side device, including:
a receiving module, configured to receive indication information reported by a terminal, where the indication information indicates whether the terminal successfully receives system information including a cell handover parameter broadcast by the network-side device.

According to a fifth aspect of the embodiments of the present disclosure, a computer-readable storage medium is provided, storing a computer program that is used for performing the information transmission method of any one of the above terminal sides.

According to a sixth aspect of the embodiments of the present disclosure, a computer-readable storage medium is provided, storing a computer program that is used for performing the information transmission method of any one of the above network-side devices.

According to a seventh aspect of the embodiments of the present disclosure, an information transmission device is provided, including:
a processor;
a memory for storing a processor-executable instruction;
where the processor is configured to perform the information transmission method according to any one of the above terminal side.

According to an eighth aspect of the embodiments of the present disclosure, an information transmission device is provided, including:
a processor;
a memory for storing a processor-executable instruction;
where the processor is configured to perform the information transmission method according to any one of the above network-side device.

The technical solutions provided by the embodiments of the present disclosure may include the following beneficial effects.

In the present disclosure, the terminal can report the indication information to the network-side device, where the indication information indicates whether the terminal successfully receives the system information including the cell handover parameter broadcast by the network-side device. In this way, the network-side device determines, based on the indication information, whether the terminal successfully receives the cell handover parameter sent through the system information, thereby reducing a cell handover latency and improving cell handover reliability.

It shall be noted that the above general description and the following detailed description are examples and explanatory only and are not restrictive of the present disclosure.

### BRIEF DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of an NTN infrastructure according to an example embodiment.

FIG. 2 is a schematic flowchart of an information transmission method according to an example embodiment.

FIG. 3 is a schematic flowchart of another information transmission method according to an example embodiment.

FIG. 4 is a schematic flowchart of another information transmission method according to an example embodiment.

FIG. 5 is a schematic flowchart of another information transmission method according to an example embodiment.

FIG. 6 is a schematic flowchart of another information transmission method according to an example embodiment.

FIG. 7 is a schematic flowchart of another information transmission method according to an example embodiment.

FIG. 8 is a schematic flowchart of another information transmission method according to an example embodiment.

FIG. 9 is a schematic flowchart of another information transmission method according to an example embodiment.

FIG. 10 is a schematic flowchart of another information transmission method according to an example embodiment.

FIG. 11 is a schematic flowchart of another information transmission method according to an example embodiment.

FIG. 12 is a schematic flowchart of another information transmission method according to an example embodiment.

FIG. 13 is a schematic flowchart of another information transmission method according to an example embodiment.

FIG. 14 is a schematic flowchart of another information transmission method according to an example embodiment.

FIG. 15 is a block diagram of an information transmission apparatus according to an example embodiment.

FIG. 16 is a block diagram of another information transmission apparatus according to an example embodiment.

FIG. 17 is a schematic structural diagram of an information transmission device according to an example embodiment of the present disclosure.

FIG. 18 is a schematic structural diagram of another information transmission device according to an example embodiment of the present disclosure.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The implementations set forth in the following description of example embodiments do not represent all implementations consistent with the present disclosure. Instead, they are merely examples of apparatuses and methods consistent with aspects related to the present disclosure as recited in the appended claims.

The terminology used herein is for the purpose of describing particular embodiments only and is not intended to be limiting of the disclosure. The singular forms “a,” “said” and “the” used in the present disclosure and the appended claims are also intended to include plural forms, unless the context clearly indicates other meanings. It will also be understood that the term “and/or” as used herein refers to and encompasses any and all possible combinations of at least one of the associated listed items.

It should be understood that although the terms first, second, third, etc. may be used in the present disclosure to describe various information, the information should not be limited to these terms. These terms are only used to distinguish a same type of information from each other. For example, without departing from the scope of the present disclosure, “first information” may also be referred to as “second information,” and similarly, “second information” may also be referred to as “first information”. Depending on the context, the word “if” as used herein may be interpreted as “when” or “upon” or “in response to determining”.

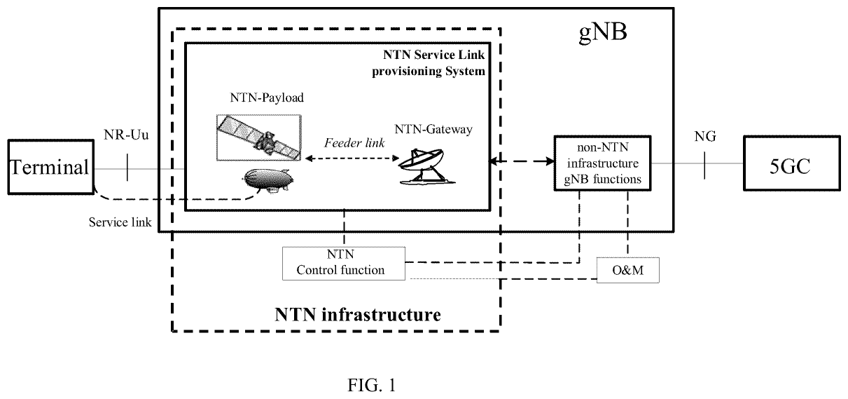

An example of an NTN infrastructure is shown in FIG. 1, it can be learnt in FIG. 1 that, even if the terminal does not move on the ground, the terminal still needs to perform cell handover due to satellite movement. For a satellite in a non-geosynchronous orbit, the satellite moves at a high speed relative to a fixed location on the earth, so that the terminal needs to be handed over frequently and inevitably, resulting in a large amount of signaling overheads.

According to a current handover mechanism, in a process in which a terminal performs cell handover, a network-side device may send, to the terminal through an RRC message, related parameters of a target base station to be handed over to. Some of the parameters of the target cell configured by the network side for the terminal through the RRC message are common parameters for multiple terminals when the terminals are handed over to the target cell. That is, the parameters are same for all terminals that need to be handed over to the cell.

Therefore, to reduce signaling overheads of cell handover, it is proposed to configure a common parameter of a target cell for a terminal in a broadcast or multicast manner, and then configure a terminal-specific parameter of a target cell for the terminal through an RRC message, thereby reducing signaling overheads.

However, if the terminal cannot correctly receive the common parameter of the target cell broadcast through the system information, a cell handover failure may occur.

To resolve the above technical problem, the present disclosure provides an information transmission method and apparatus, and a storage medium as follows. A time latency in cell handover is reduced, and the reliability of cell handover is improved.

The following first describes the information transmission method provided in the present disclosure from a terminal side.

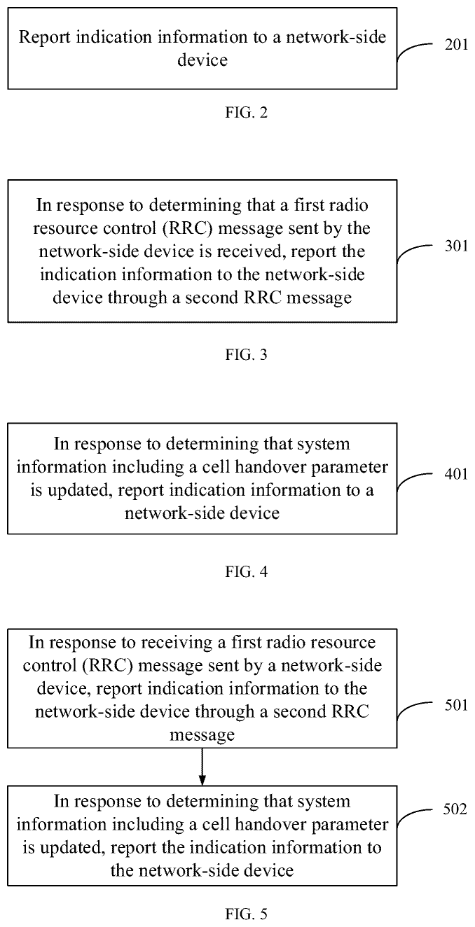

An embodiment of the present disclosure provides an information transmission method, as shown in FIG. 2, FIG. 2 is a flowchart of an information transmission method according to an embodiment, which may be performed by a terminal, and the method may include a following step.

In step 201, reporting indication information to a network-side device.

In an embodiment of the present disclosure, the indication information indicates whether the terminal successfully receives system information including a cell handover parameter broadcast by the network-side device.

In a possible implementation, the cell handover parameter includes but is not limited to a common parameter for handover to a target cell.

For example, the common parameter may include but is not limited to a common downlink configuration (DownlinkConfigCommon), a common uplink configuration (UplinkConfigCommon), etc.

In a possible implementation, when the terminal successfully receives the system information block including the cell handover parameter, it is determined that the system information is successfully received.

In another possible implementation, when the terminal stores a valid system information block including the cell handover parameter, it is determined that the system information is successfully received.

In another possible implementation, when the terminal successfully receives a system information block including the cell handover parameter, and the terminal stores a valid system information block including the cell handover parameter, it is determined that the system information is successfully received.

In the above embodiment, the terminal can report the indication information to the network-side device, and notify, through the indication information, the network-side device whether the terminal successfully receives the system information including the cell handover parameter broadcast by the network-side device. In this way, a time latency in cell handover is reduced, and the reliability of cell handover is improved.

In some optional embodiments, as shown in FIG. 3, FIG. 3 is a flowchart of an information transmission method according to an embodiment, which may be performed by a terminal, and the method may include a following step.

In step 301, in response to receiving a first radio resource control (RRC) message sent by the network-side device, reporting the indication information to the network-side device through a second RRC message.

In the embodiment of the present disclosure, the first RRC message is used to configure, for the terminal, a terminal-specific parameter for handover to a target cell. The terminal-specific parameter includes a parameter specific to the terminal other than the common parameter when the terminal is handed over to the target cell.

In a possible implementation, the terminal receives an RRC reconfiguration message sent by the network-side device, where the terminal-specific parameter for handover to the target cell is configured for the terminal in the RRC reconfiguration message.

Correspondingly, the terminal may report the indication information to the network-side device through the second RRC message, for example, an RRC reconfiguration complete message. The indication information indicates whether the terminal successfully receives system information including a cell handover parameter broadcast by the network-side device.

In the above embodiment, in response to determining that the terminal receives the first RRC message sent by the network-side device, the terminal may report the indication information to the network-side device through the second RRC message, to notify the network-side device of whether the terminal successfully receives the system information including the cell handover parameter broadcast by the network-side device, thereby reducing a cell handover latency and improving cell handover reliability.

In some optional embodiments, as shown in FIG. 4, FIG. 4 is a flowchart of an information transmission method according to an embodiment, which may be performed by a terminal, and the method may include a following step.

In step 401, in response to determining that system information including a cell handover parameter is updated, reporting indication information to a network-side device.

In an embodiment of the present disclosure, in response to determining that the system information including the cell handover parameter is updated, the terminal may report the indication information to the network-side device. That is, when the network updates the system information including the cell handover parameter, the terminal may report the indication information to the network-side device. The indication information indicates whether the terminal successfully receives the system information including the cell handover parameter broadcast by the network-side device.

In the above embodiment, in response to determining that the system information including the cell handover parameter has been updated, the terminal can report the indication information to the network-side device, to notify the network-side device of whether the terminal successfully receives the system information including the cell handover parameter broadcast by the network-side device, thereby reducing a cell handover latency and improving cell handover reliability.

In some optional embodiments, as shown in FIG. 5, FIG. 5 is a flowchart of an information transmission method according to an embodiment, which may be performed by a terminal, and the method may include following steps 501 and 502.

In step 501, in response to receiving a first radio resource control (RRC) message sent by a network-side device, reporting indication information to the network-side device through a second RRC message.

An implementation of step 501 is similar to that of step 301, and details will not be repeated herein.

In step 502, in response to determining that system information including a cell handover parameter is updated, reporting the indication information to the network-side device.

An implementation of step 502 is similar to that of step 402, and details will not be repeated herein.

It should be noted that the present disclosure does not limit the execution sequence of step 501 and step 502. That is, step 501 may be performed first, the terminal receives the first RRC message sent by the network-side device, and reports the indication information to the network-side device through the second RRC message; and then step 502 is performed, after the terminal reports the indication information, if it is determined that the system information is updated, the terminal may report the indication information again. Optionally, step 502 may be performed ahead of step 501, which is not limited in the present disclosure.

In the above embodiment, the terminal can report the indication information to the network-side device for multiple times, by which it is ensured that the network-side device receives the indication information and hence determines whether the terminal successfully receives the cell handover parameter sent through the system information, thereby reducing a cell handover latency and improving cell handover reliability.

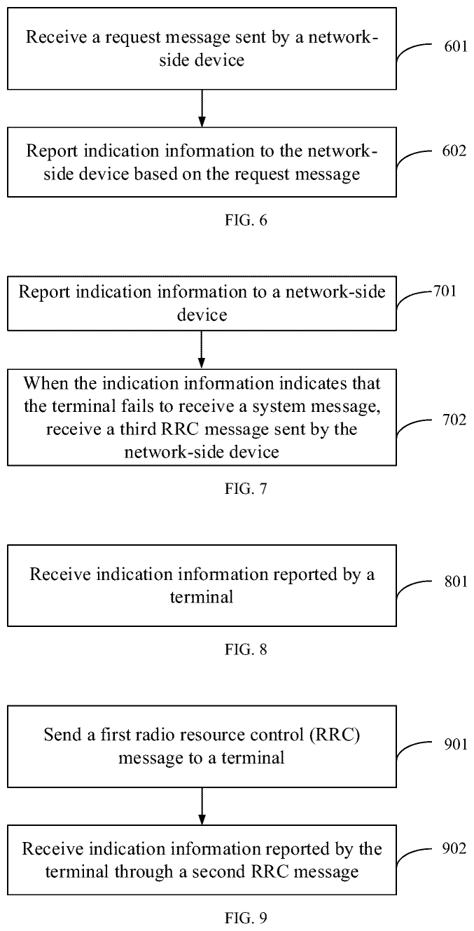

In some optional embodiments, as shown in FIG. 6, FIG. 6 is a flowchart of an information transmission method according to an embodiment, which may be performed by a terminal, and the method may include following steps 601 and 602.

In step 601, receiving a request message sent by a network-side device.

In an embodiment of the present disclosure, the request message is used to request the terminal to report the indication information.

In step 602, reporting indication information to the network-side device based on the request message.

In the embodiment of the present disclosure, the terminal may report the indication information to the network-side device in response to receiving the request message sent by the network-side device. The indication information indicates whether the terminal successfully receives system information including a cell handover parameter broadcast by the network-side device.

In the above embodiment, the terminal can report the indication information to the network-side device based on the request initiated by the network-side device. In this way, the network-side device determines, based on the indication information, whether the terminal successfully receives the cell handover parameter sent through the system information, thereby reducing a cell handover latency and improving cell handover reliability.

In some optional embodiments, as shown in FIG. 7, FIG. 7 is a flowchart of an information transmission method according to an embodiment, which may be performed by a terminal, and the method may include following steps 701 and 702.

In step 701, reporting indication information to a network-side device.

The indication information indicates whether the terminal successfully receives system information including a cell handover parameter broadcast by the network-side device. A manner in which the terminal determines whether the system information is successfully received is similar to the manner in which the terminal determines whether the system information is successfully received in step 101, and details will not be repeated herein.

In step 702, when the indication information indicates that the terminal fails to receive system information, receiving a third RRC message sent by the network-side device.

In the embodiment of the present disclosure, the third RRC message at least includes a cell handover parameter.

In a possible implementation, the third RRC message includes a system information block including a common parameter for handover to a target cell.

It should be noted that the system information block may be a system information block defined in a protocol and dedicated to send the common parameter, or a multiplexed existing system information block in a protocol, which is not limited in the present disclosure.

The network-side device may include the system information block in the third RRC message and send to the terminal.

In another possible implementation, the third RRC message may include a common parameter.

That is, when determining that the terminal fails to receive the system information, the network-side device delivers the common parameter to the terminal again through the third RRC message.

It should be noted that the system information may be a multiplexed existing system information block in the protocol or may be a system information block defined in the protocol and dedicated to send the common parameter, which is not limited in the present disclosure.

In another possible implementation, the third RRC message may include the common parameter and a terminal-specific parameter for handover to the target cell.

In the embodiment of the present disclosure, the network-side device may perform fallback when determining that the terminal fails to receive the system information. That is, a legacy parameter configuration manner is fallen back to, where the common parameter and the terminal-specific parameter for handover to the target cell are sent to the terminal through the third RRC message, that is, when determining that the terminal fails to receive the system information, the network-side device configures, for the UE through the third RRC message, all parameters required for handover to the target cell.

The third RRC message may be an RRC reconfiguration message or another RRC message, which is not limited in the present disclosure.

In the above embodiment, when the indication information reported by the terminal to the network-side device indicates that the terminal fails to receive the system information including the cell handover parameter broadcast by the network-side device, the terminal may receive the third RRC message sent by the network-side device, where the third RRC message includes at least the cell handover parameter that was not received by the terminal through the system information. This ensures that the terminal side can obtain all parameters for the cell handover, reduces a latency of the cell handover, and improves reliability of the cell handover.

The following then describes the information transmission method provided in the present disclosure from a network-side device.

An embodiment of the present disclosure provides an information transmission method, referring to FIG. 8, FIG. 8 is a flowchart of an information transmission method according to an embodiment, which may be performed by a network-side device, where the network-side device includes, but is not limited to, a base station in a non-terrestrial network (NTN), and the method may include a following step.

In step 801, receiving indication information reported by a terminal.

In an embodiment of the present disclosure, the indication information indicates whether the terminal successfully receives system information including a cell handover parameter broadcast by the network-side device.

In a possible implementation, the cell handover parameter includes but is not limited to a common parameter for handover to a target cell.

For example, the common parameter may include but is not limited to DownlinkConfigCommon, UplinkConfigCommon, etc.

In the above embodiment, the network-side device may determine, based on the indication information reported by the terminal, whether the terminal successfully receives the system information including the cell handover parameter broadcast by the network-side device. In this way, a time delay in cell handover is reduced, and the reliability of cell handover is improved.

In some optional embodiments, referring to FIG. 9, FIG. 9 is a flowchart of an information transmission method according to an embodiment, which may be performed by a network-side device, where the network-side device may include but is not limited to a base station in an NTN, and the method may include following steps 901 and 902.

In step 901, sending a first radio resource control (RRC) message to a terminal.

In the embodiment of the present disclosure, the first RRC message is used to configure, for the terminal, a terminal-specific parameter for handover to a target cell. The terminal-specific parameter includes a parameter specific to the terminal other than the common parameter when the terminal is handed over to the target cell. The first RRC message may be an RRC reconfiguration message.

In a possible implementation, the network-side device sends an RRC reconfiguration message to the terminal, where a terminal-specific parameter for handover to a target cell is configured for the terminal in the RRC reconfiguration message.

In step 902, receiving indication information reported by the terminal through a second RRC message.

In an embodiment of the present disclosure, the second RRC message may be an RRC reconfiguration complete message.

After sending the first RRC message to the terminal, the network-side device may receive the indication information reported by the terminal through the second RRC message, for example, reported by the terminal through an RRC reconfiguration complete message. The indication information indicates whether the terminal successfully receives system information including a cell handover parameter broadcast by the network-side device.

In the above embodiment, after sending the first RRC message to the terminal, the network-side device may receive the indication information reported by the terminal through the second RRC message, thereby reducing a cell handover latency and improving cell handover reliability.

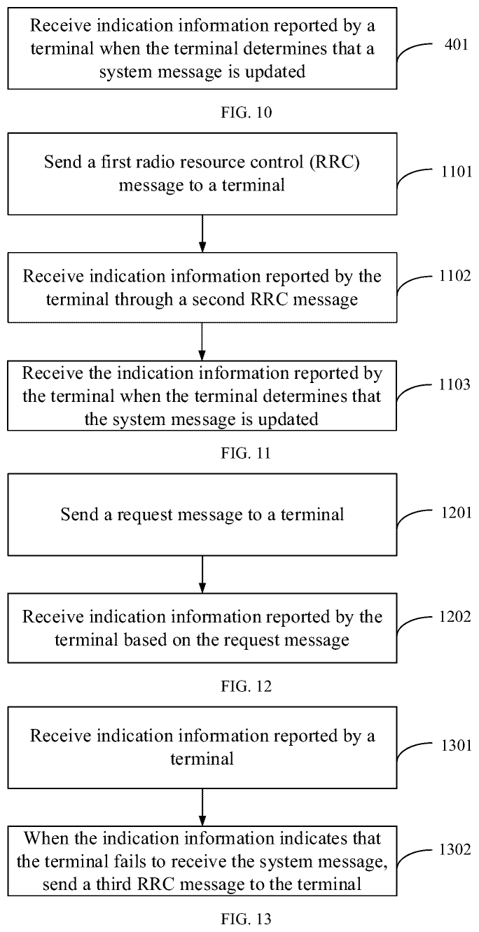

In some optional embodiments, referring to FIG. 10, FIG. 10 is a flowchart of an information transmission method according to an embodiment, which may be performed by a network-side device, where the network-side device may include but is not limited to a base station in an NTN, and the method may include a following step.

In step 1001, receiving indication information reported by a terminal when the terminal determines that system information is updated.

In an embodiment of the present disclosure, the network-side device may receive the indication information reported by the terminal when the terminal determines that the system information including the cell handover parameter is updated. The indication information indicates whether the terminal successfully receives the system information including the cell handover parameter broadcast by the network-side device. That is, when the network device updates the system information including the cell handover parameter, the network device receives the indication information sent by the terminal.

In the above embodiment, the network-side device determines, based on the indication information reported by the terminal, whether the terminal successfully receives the system information including the cell handover parameter broadcast by the network-side device, thereby reducing a cell handover latency and improving cell handover reliability.

In some optional embodiments, referring to FIG. 11, FIG. 11 is a flowchart of an information transmission method according to an embodiment, which may be performed by a network-side device, where the network-side device may include but is not limited to a base station in an NTN, and the method may include following steps 1101-1103.

In step 1101, sending a first radio resource control (RRC) message to a terminal.

In the embodiment of the present disclosure, the first RRC message is used to configure, for the terminal, a terminal-specific parameter for handover to a target cell. The terminal-specific parameter includes a parameter specific to the terminal other than the common parameter when the terminal is handed over to the target cell. The first RRC message may be an RRC reconfiguration message.

In a possible implementation, the network-side device sends an RRC reconfiguration message to the terminal, where a terminal-specific parameter for handover to a target cell is configured for the terminal in the RRC reconfiguration message.

In step 1102, receiving indication information reported by the terminal through a second RRC message.

In an embodiment of the present disclosure, the second RRC message may be an RRC reconfiguration complete message.

After sending the first RRC message to the terminal, the network-side device may receive the indication information reported by the terminal through the second RRC message, for example, reported by the terminal through an RRC reconfiguration complete message. The indication information indicates whether the terminal successfully receives system information including a cell handover parameter broadcast by the network-side device.

In step 1103, receiving the indication information reported by the terminal when the terminal determines that the system information is updated.

In the embodiment of the present disclosure, the execution order of steps 1101, 1102 and 1103 is not limited to the present disclosure. That is, steps 1101 and 1102 may be performed first, and then step 1103 is performed. Optionally, step 1103 may be performed first, and then steps 1101 and 1102 are performed, which is not limited in the present disclosure.

In the above embodiment, the network-side device can receive the indication information reported by the terminal for multiple times, by which it is ensured that the network-side device receives the indication information and hence determines whether the terminal successfully receives the cell handover parameter sent through the system information, thereby reducing a cell handover latency and improving cell handover reliability.

In some optional embodiments, referring to FIG. 12, FIG. 12 is a flowchart of an information transmission method according to an embodiment, which may be performed by a network-side device, where the network-side device may include but is not limited to a base station in an NTN, and the method may include following steps 1201-1202.

In step 1201, sending a request message to a terminal.

In an embodiment of the present disclosure, the request message is used to request the terminal to report the indication information. The indication information indicates whether the terminal successfully receives system information including a cell handover parameter broadcast by the network-side device.

In step 1202, receiving indication information reported by the terminal based on the request message.

In the above embodiment, the network-side device can request the terminal to report the indication information, so that the network-side device can determine, based on the indication information reported by the terminal, whether the terminal successfully receives the cell handover parameter sent through the system information, thereby reducing a cell handover latency and improving cell handover reliability.

In some optional embodiments, referring to FIG. 13, FIG. 13 is a flowchart of an information transmission method according to an embodiment, which may be performed by a network-side device, where the network-side device may include but is not limited to a base station in an NTN, and the method may include following steps 1301 and 1302.

In step 1301, receiving indication information reported by a terminal.

In an embodiment of the present disclosure, the indication information indicates whether the terminal successfully receives system information including a cell handover parameter broadcast by the network-side device.

In step 1302, when the indication information indicates that the terminal fails to receive the system information, sending a third RRC message to the terminal.

In an embodiment of the present disclosure, the third RRC message at least includes the cell handover parameter transmitted by the network-side device through the system information.

In a possible implementation, the third RRC message includes a system information block including a common parameter for handover to a target cell.

It should be noted that the system information block may be a system information block defined in a protocol and dedicated to send the common parameter, or a multiplexed existing system information block in a protocol, which is not limited in the present disclosure.

The network-side device may include the system information block in the third RRC message and send to the terminal.

In another possible implementation, the third RRC message may include a common parameter.

That is, when determining that the terminal fails to receive the system information, the network-side device delivers the common parameter to the terminal again through the third RRC message.

It should be noted that the system information may be a multiplexed existing system information block in the protocol or may be a system information block defined in the protocol and dedicated to send the common parameter, which is not limited in the present disclosure.

In another possible implementation, the third RRC message may include the common parameter and a terminal-specific parameter for handover to the target cell.

In the embodiment of the present disclosure, the network-side device may perform fallback when determining that the terminal fails to receive the system information. That is, a legacy parameter configuration mode is fallen back to, the common parameter and the terminal-specific parameter for handover to the target cell are sent to the terminal together through the third RRC message, that is, all parameters required for handover of the terminal to the target cell are sent to the terminal through the third RRC message.

The third RRC message may be an RRC reconfiguration message or another RRC message, which is not limited in the present disclosure.

In the above embodiment, when the indication information reported by the terminal to the network-side device indicates that the terminal fails to receive the system information including the cell handover parameter broadcast by the network-side device, the network-side device can send the third RRC message to the terminal, where the third RRC message includes at least the cell handover parameter that was not received by the terminal through the system information. This ensures that the terminal side can obtain all parameters for the cell handover, reduces the latency of the cell handover, and improves the reliability of the cell handover.

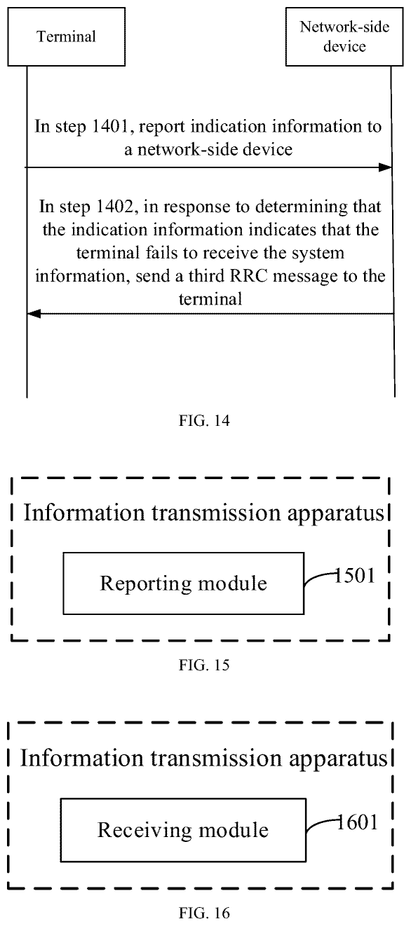

In some optional embodiments, referring to FIG. 14, FIG. 14 is a flowchart of an information transmission method according to an embodiment, and the method may include following steps 1401-1402.

In step 1401, a terminal reports indication information to a network-side device.

The indication information indicates whether the terminal successfully receives system information including a cell handover parameter broadcast by the network-side device.

In a possible implementation, in response to receiving a first RRC message sent by the network-side device, where the first RRC message is used to configure, for the terminal, a terminal-specific parameter for handover to a target cell, the terminal reports the indication information to the network-side device through a second RRC message.

In another possible implementation, in response to determining that the system information including the cell handover parameter is updated, the terminal reports the indication information to the network-side device.

In another possible implementation, in response to receiving a first RRC message sent by the network-side device and determining that the system information including the cell handover parameter is updated, the terminal reports the indication information to the network-side device.

In another possible implementation, in response to receiving a request message sent by the network-side device, where the request message is used to request the terminal to report the indication information, the terminal reports the indication information to the network-side device.

When the indication information indicates that the terminal successfully receives the system information including the cell handover parameter broadcast by the network-side device, the network-side device does not need to perform step 1402. When the indication information indicates that the terminal fails to receive the system information including the cell handover parameter broadcast by the network-side device, the network-side device continues to perform step 1402.

In step 1402, in response to determining that the indication information indicates that the terminal fails to receive the system information, the network-side device sends a third RRC message to the terminal, where the third RRC message at least includes the cell handover parameter.

An implementation of step 1402 is similar to that of step 1302, which will not be repeated herein.

In the above embodiment, when the indication information reported by the terminal to the network-side device indicates that the terminal fails to receive the system information including the cell handover parameter broadcast by the network-side device, the network-side device can send the third RRC message to the terminal, where the third RRC message includes at least the cell handover parameter that was not received by the terminal through the system information. This ensures that the terminal side can obtain all parameters for the cell handover, reduces the latency of the cell handover, and improves the reliability of the cell handover.

Corresponding to the above embodiments of application function implementation method, the present disclosure further provides embodiments of an application function implementation apparatus.

Referring to FIG. 15, FIG. 15 is a block diagram of an information transmission apparatus according to an example embodiment. The apparatus is applied to a terminal, and includes:
a reporting module 1501, configured to report indication information to a network-side device, where the indication information indicates whether the terminal successfully receives system information including a cell handover parameter broadcast by the network-side device.

Referring to FIG. 16, FIG. 16 is a block diagram of an information transmission apparatus according to an example embodiment. The apparatus is applied to a network-side device, and includes:
a receiving module 1601, configured to receive indication information reported by a terminal, where the indication information indicates whether the terminal successfully receives system information including a cell handover parameter broadcast by the network-side device.

For the apparatus embodiments, as they basically correspond to the method embodiments, relevant parts can be referred from the description of the method embodiments. The apparatus embodiments described above are merely illustrative, where the units described as separate components may or may not be physically separated, and the components displayed as units may or may not be physical units, that is, may be located in one place, or may be distributed on a plurality of network units. Some or all of the modules may be selected according to actual needs to achieve the objectives of the solutions of the present disclosure. A person of ordinary skill in the art may understand and implement the embodiments of the present disclosure without making creative efforts.

Correspondingly, the present disclosure further provides a computer-readable storage medium storing a computer program, where the computer program is used for performing the information transmission method for the terminal side described above.

Correspondingly, the present disclosure further provides a computer-readable storage medium storing a computer program, where the computer program is used for performing the information transmission method for the network-side device described above.

Correspondingly, the present disclosure further provides an information transmission device, including:
a processor;
a memory for storing a processor-executable instruction;
where the processor is configured to perform the information transmission method according to any one of the above terminal side.

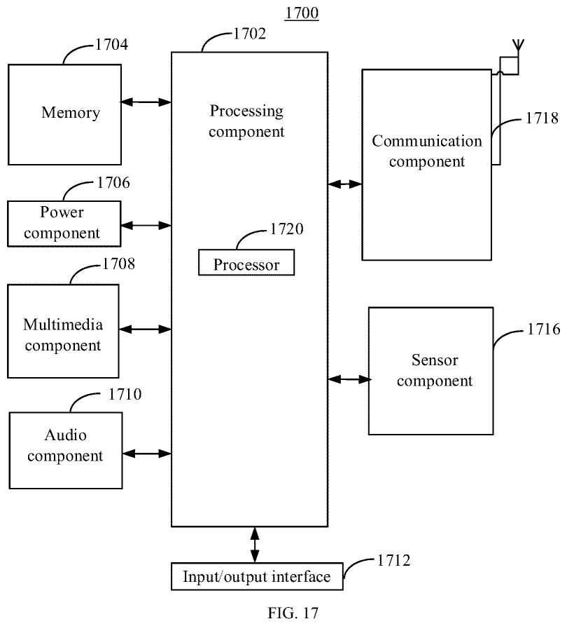

FIG. 17 is a block diagram of an information transmission device 1700 according to an example embodiment. For example, the device 1700 may be a terminal such as a mobile phone, a tablet computer, an e-book reader, a multimedia playback device, a wearable device, vehicle-mounted user equipment, an iPad, or a smart television.

Referring to FIG. 17, the device 1700 may include one or more of the following components: a processing component 1702, a memory 1704, a power component 1706, a multimedia component 1708, an audio component 1710, an input/output (I/O) interface 1712, a sensor component 1716, and a communication component 1718.

The processing component 1702 typically controls the overall operations of the device 1700, such as the operations associated with display, telephone calls, data random access, camera operations, and recording operations. The processing component 1702 may include one or more processors 1720 to execute instructions to perform all or part of the steps in the above information transmission method. Moreover, the processing component 1702 may include one or more modules that facilitate the interaction between the processing component 1702 and other components. For example, the processing component 1702 may include a multimedia module to facilitate the interaction between the multimedia component 1708 and the processing component 1702. For another example, the processing component 1702 may read executable instructions from the memory to implement the steps of the information transmission method provided by the above embodiments.

The memory 1704 is configured to store various types of data to support the operation of the device 1700. Examples of such data include instructions for any applications or methods operated on the device 1700, contact data, phonebook data, messages, pictures, video, etc. The memory 1704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1706 provides power to various components of the device 1700. The power component 1706 may include a power management system, one or more power sources, and any other components associated with the generation, management, and distribution of power in the device 1700.

The multimedia component 1708 includes a display screen providing an output interface between the device 1700 and the user. In some embodiments, the multimedia component 1708 includes a front camera and/or a rear camera. The front camera and the rear camera may receive an external multimedia datum while the device 1700 is in an operation mode, such as a photographing mode or a video mode. Each of the front camera and the rear camera may be a fixed optical lens system or have focal length and optical zoom capability.

The audio component 1710 is configured to output and/or input audio signals. For example, the audio component 1710 includes a microphone (MIC) configured to receive an external audio signal when the device 1700 is in an operation mode, such as a call mode, a recording mode, and a voice recognition mode. The received audio signal may be further stored in the memory 1704 or transmitted via the communication component 1718. In some embodiments, the audio component 1710 further includes a speaker to output audio signals.

The I/O interface 1712 provides an interface between the processing component 1702 and peripheral interface modules, such as a keyboard, a click wheel, buttons, and the like. These buttons may include, but are not limited to, home buttons, volume buttons, start buttons, and lock buttons.

The sensor component 1716 includes one or more sensors to provide status assessments of various aspects of the device 1700. For instance, the sensor component 1716 may detect an open/closed status of the device 1700, relative positioning of components, e.g., the display and the keypad, of the device 1700, a change in position of the device 1700 or a component of the device 1700, a presence or absence of user contact with the device 1700, an orientation or an acceleration/deceleration of the device 1700, and a change in temperature of the device 1700. The sensor component 1716 may include a proximity sensor configured to detect the presence of nearby objects without requiring any physical contact. The sensor component 1716 may also include a light sensor, such as a CMOS or CCD image sensor, for use in imaging applications. In some embodiments, the sensor component 1716 may also include an accelerometer sensor, a gyroscope sensor, a magnetic sensor, a pressure sensor, or a temperature sensor.

The communication component 1718 is configured to facilitate communication, wired or wirelessly, between the device 1700 and other devices. The device 1700 can access a wireless network based on a communication standard, such as Wi-Fi, 2G, 3G, 4G, 5G or 6G, or a combination thereof. In an example embodiment, the communication component 1718 receives a broadcast signal or broadcast associated information from an external broadcast management system via a broadcast channel. In an example embodiment, the communication component 1718 further includes a near field communication (NFC) module to facilitate short-range communications. For example, NFC modules may be implemented based on radio frequency identification (RFID) technology, infrared data association (IrDA) technology, ultra-wideband (UWB) technology, Bluetooth (BT) technology, and other technologies.

In an example embodiment, the device 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing any of the above information transmission methods on the terminal side.

In an example embodiment, there is also provided a non-transitory machine-readable storage medium including instructions, such as included in the memory 1704, executable by the processor 1720 in the device 1700, for performing the above-described methods for transmitting information. For example, the non-transitory computer-readable storage medium may be a ROM (read-only memory), a RAM (random access memory), CD-ROM (compact disc read-only memory), magnetic tape, floppy disk, optical data storage device, or the like.

Correspondingly, the present disclosure further provides an information transmission device, including:
a processor;
a memory for storing a processor-executable instruction;
where the processor is configured to perform the information transmission method according to any one of the above network-side devices.

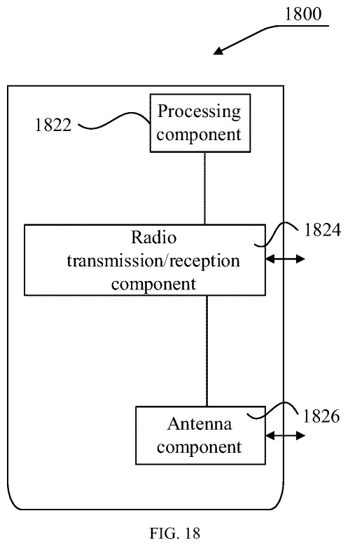

FIG. 18 is a schematic structural diagram of an information transmission device 1800 according to an example embodiment. The device 1800 may be provided as a network-side device. Referring to FIG. 18, the device 1800 includes a processing component 1822, a radio transmission/reception component 1824, an antenna component 1826, and a signal processing portion specific to a radio interface, and the processing component 1822 may further include at least one processor.

One of the processors in the processing component 1822 may be configured to perform any of the information transmission methods described above on the network-side device.

Other embodiments of the present disclosure will be apparent to those skilled in the art from consideration of the specification and practice of the present disclosure disclosed herein. The present disclosure is intended to cover any variations, uses, or adaptations of the present disclosure following the general principles thereof and including such departures from the present disclosure as come within known or customary practice in the art. It is intended that the specification and examples be considered as examples only, with a true scope and spirit of the disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. An method for information transmission, performed by a terminal, the method comprising:
reporting indication information to a network-side device, wherein the indication information indicates whether the terminal successfully receives system information comprising a cell handover parameter broadcast by the network-side device.

2. The method according to claim 1, wherein the cell handover parameter comprises:
a common parameter for handover to a target cell.

3. The method according to claim 1, further comprising:
in response to determining that a system information block comprising the cell handover parameter is successfully received, determining that the system information is successfully received; and/or
in response to determining that a valid system information block comprising the cell handover parameter is stored, determining that the system information is successfully received.

4. The method according to claim 1, wherein reporting the indication information to the network-side device comprises:
in response to receiving a first radio resource control (RRC) message sent by the network-side device, reporting the indication information to the network-side device through a second RRC message, wherein the first RRC message is used to configure, for the terminal, a terminal-specific parameter for handover to a target cell.

5. The method according to claim 1, wherein reporting the indication information to the network-side device comprises:
in response to determining that the system information comprising the cell handover parameter is updated, reporting the indication information to the network-side device.

6. The method according to claim 1, wherein reporting the indication information to the network-side device comprises:
in response to receiving a first RRC message sent by the network-side device, reporting the indication information to the network-side device through a second RRC message, wherein the first RRC message is used to configure, for the terminal, a terminal-specific parameter for handover to a target cell; and
in response to determining that the system information comprising the cell handover parameter is updated, reporting the indication information to the network-side device.

7. The method according to claim 4, wherein the first RRC message is an RRC reconfiguration message; and/or
the second RRC message is an RRC reconfiguration complete message.

8. The method according to claim 1, further comprising:
receiving a request message sent by the network-side device, wherein the request message is used to request the terminal to report the indication information;
wherein reporting the indication information to the network-side device comprises:
reporting the indication information to the network-side device based on the request message.

9. The method according to claim 1, further comprising:
in response to determining that the indication information indicates that the terminal fails to receive the system information, receiving a third RRC message sent by the network-side device, wherein the third RRC message comprises the cell handover parameter.

10. The method according to claim 9, wherein the third RRC message comprises at least one of:
a system information block comprising a common parameter for handover to a target cell;
the common parameter; or
the common parameter and a terminal-specific parameter for handover to the target cell.

11. An method for information transmission, performed by a network-side device, the method comprising:
receiving indication information reported by a terminal, wherein the indication information indicates whether the terminal successfully receives system information comprising a cell handover parameter broadcast by the network-side device.

12. The method according to claim 11, wherein the cell handover parameter comprises:
a common parameter for handover to a target cell.

13. The method according to claim 11, wherein
receiving the indication information reported by the terminal comprises:
after sending a first radio resource control (RRC) message to the terminal, receiving the indication information reported by the terminal through a second RRC message, wherein the first RRC message is used to configure, for the terminal, a terminal-specific parameter for handover to a target cell.

14. The method according to claim 11, wherein receiving the indication information reported by the terminal comprises:
receiving the indication information reported when the terminal determines that the system information is updated.

15. The method according to claim 11, wherein receiving the indication information reported by the terminal comprises:
after sending a first RRC message to the terminal, receiving the indication information reported by the terminal through a second RRC message, wherein the first RRC message is used to configure, for the terminal, a terminal-specific parameter for handover to a target cell; and
receiving the indication information reported by the terminal when the terminal determines that the system information is updated.

16. The method according to claim 13, wherein the first RRC message is an RRC reconfiguration message; and/or
the second RRC message is an RRC reconfiguration complete message.

17. The method according to claim 11, further comprising:
sending a request message to the terminal, wherein the request message is used to request the terminal to report the indication information;
receiving the indication information reported by the terminal comprises:
receiving the indication information reported by the terminal based on the request message.

18. The method according to claim 11, further comprising:
in response to determining that the indication information indicates that the terminal fails to receive the system information, sending a third RRC message to the terminal, wherein the third RRC message comprises the cell handover parameter ;.
wherein the third RRC message comprises at least one of:
a system information block comprising a common parameter for handover to a target cell;
the common parameter; or
the common parameter and a terminal-specific parameter for handover to the target cell.

19.-22. (canceled)

23. An information transmission device, comprising:
a processor;
a memory for storing a processor-executable instruction;
wherein the processor-executable instruction when executed by the processor cause the information transmission device to act as the terminal and perform the method according to claim 1.

24. An information transmission device, comprising:
a processor;
a memory for storing a processor-executable instruction;
wherein the processor-executable instruction when executed by the processor cause the information transmission device to act as the network-side device and perform the method according to claim 11.
